(19) United States
(12) Patent Application Publication
(10) Pub. No.: US 2026/0044458 A1
(43) Pub. Date: Feb. 12, 2026

(54) MEMORY SYSTEM INCLUDING ADAPTABLE PHYSICAL CONNECTIVITY

(71) Applicant: SK hynix Inc., Icheon-si Gyeonggi-do (KR)

(72) Inventor: Ie Ryung PARK, Icheon-si Gyeonggi-do (KR)

(73) Assignee: SK hynix Inc., Icheon-si Gyeonggi-do (KR)

(21) Appl. No.: 18/959,126

(22) Filed: Nov. 25, 2024

(30) Foreign Application Priority Data
Aug. 6, 2024 (KR) 10-2024-0104954

(51) Int. Cl. G06F 13/16

(52) U.S. Cl. CPC G06F 13/161; G06F 13/1657; G06F 13/1668

(57) ABSTRACT

A memory system includes a computing device including one or more control physical channels and a memory device including a plurality of memory physical channels. A memory physical channel, among the plurality of memory physical channels, that is connected to a first control physical channel among the one or more control physical channels is activated.

### CROSS-REFERENCE TO RELATED APPLICATION

The present application claims priority under 35 U.S.C. § 119(a) to Korean Patent Application No. 10-2024-0104954, filed in the Korean Intellectual Property Office on Aug. 6, 2024, the entire contents of which application is incorporated herein by reference.

### BACKGROUND

### 1. Technical Field

The present disclosure relates to a memory system, including but not limited to memory system connectivity.

### 2. Related Art

Stack memory systems, such as high bandwidth memory (HBM), are used in wide variety of applications due to excellent bandwidth and energy efficiency. Unlike existing memory systems using a parallel data bus, stack memory systems include a stack memory device including a base chip and a plurality of core chips that are connected by through silicon vias (TSVs). Stack memory devices include a physical interface, such as a physical layer, for communication with a processor. Parameters associated with the physical layer facilitate high-speed data transmission and efficient communication.

### SUMMARY

In an embodiment, a memory system may include a computing device including a control physical channel and a memory device including a plurality of memory physical channels. In an embodiment, at least one memory physical channel that is connected to the control physical channel, among the plurality of memory physical channels, is activated.

In an embodiment, a memory system may include a computing device including a first control physical channel and a second control physical channel and a first memory device including a first memory physical channel and a second memory physical channel. In an embodiment, the first memory physical channel and the second memory physical channel are activated when the first memory physical channel and the second memory physical channel are connected to the first control physical channel.

In an embodiment, a memory system may include a base chip and a memory chip that is stacked on or over the base chip and connected to the base chip using a through silicon via (TSV). In an embodiment, the base chip includes a selector configured to connect a first memory physical channel or a second memory physical channel and an output circuit based on a selection signal.

In an embodiment, a method may include transmitting an acknowledgement request signal from a plurality of control physical channels included in a computing device to a plurality of memory physical channels included in a memory device; in response to receiving the acknowledgement request signal, transmitting an acknowledgement signal from a subset of the plurality of memory physical channels included in the memory device to a subset of the plurality of control physical channels included in the computing device; in response to receiving the acknowledgement signal, generating an activation signal indicating which of the subset of the plurality of memory physical channels is connected to which of the subset of the plurality of control physical channels; transmitting the activation signal to the memory device; and in response to receiving the activation signal, activating, by the memory device, the subset of the plurality of memory physical channels.

### BRIEF DESCRIPTION OF THE DRAWINGS

FIG. 1 illustrates a construction of a memory system according to an embodiment of the present disclosure.

FIG. 2 illustrates a construction of a memory device according to an embodiment of the present disclosure.

FIG. 3 illustrates a construction of a memory device according to an embodiment of the present disclosure.

FIG. 4 illustrates a construction of a memory system according to an embodiment of the present disclosure.

FIG. 5 and FIG. 6 illustrate a computing device and a memory device including signals utilized during a method of determining whether to activate memory physical channels according to an embodiment of the present disclosure.

FIG. 7 is a block diagram illustrating an example of a stack memory system according to an embodiment of the present disclosure.

### DETAILED DESCRIPTION

In the descriptions of the following embodiments, the term “preset” indicates that the numerical value of a parameter is previously decided, for example, when the parameter is used in a process or algorithm. According to an embodiment, the numerical value of the parameter may be preset or predetermined, prior to a start of a process or algorithm, when the process or algorithm is started, or while the process or algorithm is performed.

Terms such as “first” and “second” are used to distinguish between various elements and do not imply size, order, priority, quantity, or importance of the elements. For example, a first element may be referred to as a second element in one example, and the second element may be referred to as a first element in another example.

When one component is identified as “connected” to another component, the components may be connected directly or through an intervening component between the components. When two components are identified as “directly connected,” one component is directly connected to the other component without an intervening component between the two components.

A “logic high level” and a “logic low level” are used to describe the logic levels of signals. A signal having a “logic high level” is distinguished from a signal having a “logic low level. ” For example, when a signal having a first voltage corresponds to a signal having a “logic high level,” a signal having a second voltage may correspond to a signal having a “logic low level.” According to an embodiment, a “logic high level” may be set to a voltage higher than a “logic low level.” According to an embodiment, the logic levels of signals may be set to different logic levels or opposite logic levels. For example, a signal having a logic high level may be set to have a logic low level in some embodiments, and a signal having a logic low level may be set to have a logic high level in some embodiments.

A “bit set” includes a combination of logic levels of bits included in a signal. When a logic level of the bits included in the signal is changed, a bit set of the signal is different. For example, when the signal includes a first combination of two bits, a bit set of the signal is a first bit set, and when the signal includes a second combination of two bits, the bit set of the signal is a second bit set.

Embodiments of the present disclosure are described in detail with reference to the accompanying drawings. Specific structural or functional descriptions of embodiments are provided as examples for illustrative purposes to describe concepts that are disclosed in the present application. Examples or embodiments in accordance with the concepts may be carried out in various forms, and the scope of the present disclosure is not limited to the examples or embodiments described in this specification.

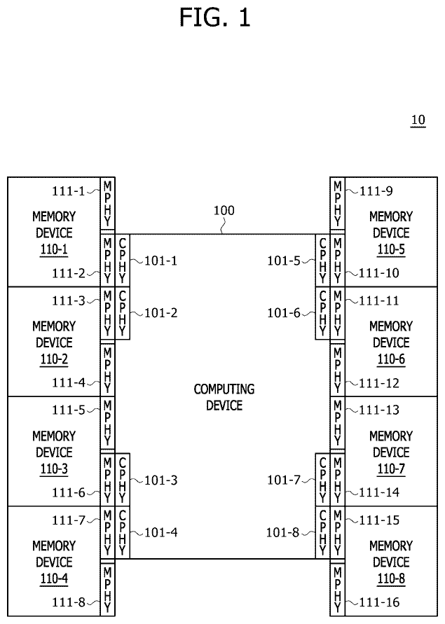

FIG. 1 illustrates a construction of a memory system 10 according to an embodiment of the present disclosure.

As illustrated in FIG. 1, the memory system 10 includes a computing device 100 and a first memory device 110-1, a second memory device 110-2, a third memory device 110-3, a fourth memory device 110-4, a fifth memory device 110-5, a sixth memory device 110-6, a seventh memory device 110-7, and an eighth memory device 110-8.

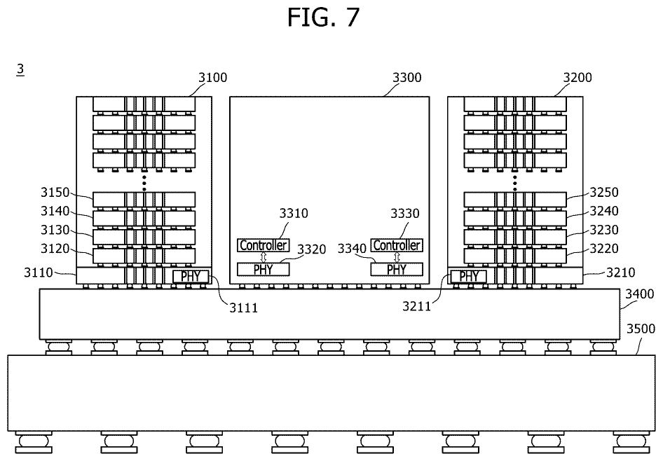

The computing device 100 is implemented with a processor, for example, processor 3300 in FIG. 7, that performs operations to facilitate various tasks. The computing device 100 may include any of a central processing unit (CPU) that controls the execution of an operating system and software, a graphic processing unit (GPU) that controls graphic rendering and parallel processing tasks, and a neural processing unit (NPU) that controls artificial intelligence and machine learning tasks such as neural network inference and training. The computing device 100 stores data utilized in an arithmetic operation in the memory devices 110-1, 110-2, 110-3, 110-4, 110-5, 110-6, 110-7, and 110-8. The computing device 100 reads data utilized in an arithmetic operation from the memory devices 110-1, 110-2, 110-3, 110-4, 110-5, 110-6, 110-7, and 110-8.

The computing device 100 includes a first control physical channel CPHY 101-1, a second control physical channel 101-2, a third control physical channel 101-3, a fourth control physical channel 101-4, a fifth control physical channel 101-5, a sixth control physical channel 101-6, a seventh control physical channel 101-7, and an eighth control physical channel 101-8.

The first control physical channel 101-1 is electrically connected to a second memory physical channel MPHY 111-2 of the first memory device 110-1. The first control physical channel 101-1 includes a physical connection that transmits data utilized in an arithmetic operation to the first memory device 110-1 and that receives data utilized in an arithmetic operation from the first memory device 110-1. The first control physical channel 101-1 converts data into an electrical, optical, or electromagnetic signal and converts signals into data. The first control physical channel 101-1 is configured to synchronize the computing device 100 and the first memory device 110-1 and detect any errors in data transmitted between the computing device 100 and the first memory device 110-1.

The second control physical channel 101-2 is electrically connected to a third memory physical channel MPHY 111-3 of the second memory device 110-2. The second control physical channel 101-2 includes a physical connection that transmits data utilized in an arithmetic operation to the second memory device 110-2 and that receives data utilized in an arithmetic operation from the second memory device 110-2. The second control physical channel 101-2 converts data into an electrical, optical, or electromagnetic signal and converts signals into data. The second control physical channel 101-2 is configured to synchronize the computing device 100 and the second memory device 110-2 and detect any errors in data transmitted between the computing device 100 and the second memory device 110-2.

The third control physical channel 101-3 is electrically connected to a sixth memory physical channel MPHY 111-6 of the third memory device 110-3. The third control physical channel 101-3 includes a physical connection that transmits data utilized in an arithmetic operation to the third memory device 110-3 and that receives data utilized in an arithmetic operation from the third memory device 110-3. The third control physical channel 101-3 converts data into an electrical, optical, or electromagnetic signal and converts signals into data. The third control physical channel 101-3 is configured to synchronize the computing device 100 and the third memory device 110-3 and detect any errors in data transmitted between the computing device 100 and the third memory device 110-3.

The fourth control physical channel 101-4 is electrically connected to a seventh memory physical channel MPHY 111-7 of the fourth memory device 110-4. The fourth control physical channel 101-4 includes a physical connection that transmits data utilized in an arithmetic operation to the fourth memory device 110-4 and that receives data utilized in an arithmetic operation from the fourth memory device 110-4. The fourth control physical channel 101-4 converts data into an electrical, optical, or electromagnetic signal and converts signals into data. The fourth control physical channel 101-4 is configured to synchronize the computing device 100 and the fourth memory device 110-4 and detect any errors in data transmitted between the computing device 100 and the fourth memory device 110-4.

The fifth control physical channel 101-5 is electrically connected to a tenth memory physical channel MPHY 111-10 of the fifth memory device 110-5. The fifth control physical channel 101-5 includes a physical connection that transmits data utilized in an arithmetic operation to the fifth memory device 110-5 and that receives data utilized in an arithmetic operation from the fifth memory device 110-5. The fifth control physical channel 101-5 converts data into an electrical, optical, or electromagnetic signal and converts signals into data. The fifth control physical channel 101-5 is configured to synchronize the computing device 100 and the fifth memory device 110-5 and detect any errors in data transmitted between the computing device 100 and the fifth memory device 110-5.

The sixth control physical channel 101-6 is electrically connected to an eleventh memory physical channel MPHY 111-11 of the sixth memory device 110-6. The sixth control physical channel 101-6 includes a physical connection that transmits data utilized in an arithmetic operation to the sixth memory device 110-6 and that receives data utilized in an arithmetic operation from the sixth memory device 110-6. The sixth control physical channel 101-6 converts data into an electrical, optical, or electromagnetic signal and converts signals into data. The sixth control physical channel 101-6 is configured to synchronize the computing device 100 and the sixth memory device 110-6 and detect any errors in data transmitted between the computing device 100 and the sixth memory device 110-6.

The seventh control physical channel 101-7 is electrically connected to a fourteenth memory physical channel MPHY 111-14 of the seventh memory device 110-7. The seventh control physical channel 101-7 includes a physical connection that transmits data utilized in an arithmetic operation to the seventh memory device 110-7 and that receives data utilized in an arithmetic operation from the seventh memory device 110-7. The seventh control physical channel 101-7 converts data into an electrical, optical, or electromagnetic signal and converts signals into data. The seventh control physical channel 101-7 is configured to synchronize the computing device 100 and the seventh memory device 110-7 and detect any errors in data transmitted between the computing device 100 and the seventh memory device 110-7.

The eighth control physical channel 101-8 is electrically connected to the fifteenth memory physical channel MPHY 111-15 of the eighth memory device 110-8. The eighth control physical channel 101-8 includes a physical connection that transmits data utilized in an arithmetic operation to the eighth memory device 110-8 and that receives data utilized in an arithmetic operation from the eighth memory device 110-8. The eighth control physical channel 101-8 converts data into an electrical, optical, or electromagnetic signal and converts signals into data. The eighth control physical channel 101-8 is configured to synchronize the computing device 100 and the eighth memory device 110-8 and detects any errors in data transmitted between the computing device 100 and the eighth memory device 110-8.

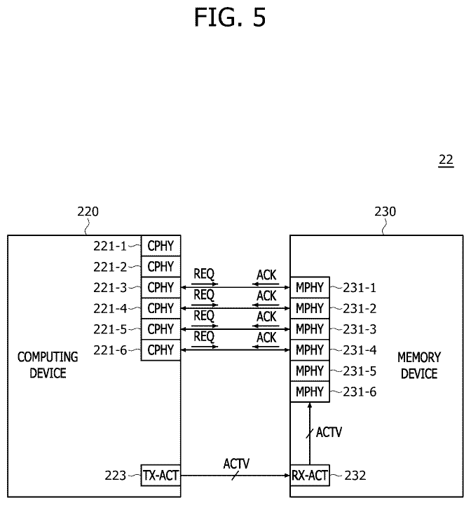

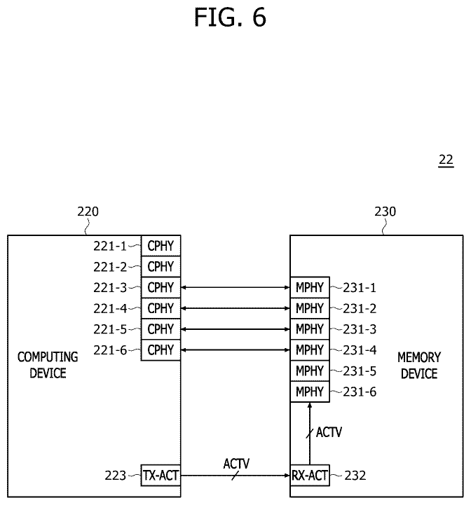

The first memory device 110-1 includes a first memory physical channel MPHY 111-1 and the second memory physical channel 111-2. Each of the first memory physical channel 111-1 and the second memory physical channel 111-2 includes a physical connection that transmits data utilized in an arithmetic operation to the computing device 100 and that receives data utilized in an arithmetic operation from the computing device 100. Each of the first memory physical channel 111-1 and the second memory physical channel 111-2 is configured to convert data into an electrical, optical, or electromagnetic signal and convert signals into data. Each of the first memory physical channel 111-1 and the second memory physical channel 111-2 is configured to synchronize the computing device 100 and the first memory device 110-1 and detect any errors in data transmitted between the computing device 100 and the first memory device 110-1. The activation of the first memory physical channel 111-1 and the second memory physical channel 111-2 is determined based on which of the first memory physical channel 111-1 and the second memory physical channel 111-2 is connected to the computing device 100. Because the second memory physical channel 111-2, and not the first memory physical channel 111-1, is connected to the first control physical channel 101-1 of the computing device 100, the first memory physical channel 111-1 is deactivated, and the second memory physical channel 111-2 is activated. For example, the activation of the first memory physical channel 111-1 and the second memory physical channel 111-2 is determined by an activation signal transmitted by the computing device 100, for example, activation signal ACTV such as shown in FIG. 5 and FIG. 6. In a first example, the activation signal ACTV such as shown in FIG. 5 and FIG. 6 is generated by the computing device 100 that issues or transmits an acknowledgement request signal REQ to the memory device 230 such as shown in FIG. 5 and the computing device 100 receives an acknowledgement signal ACK from the memory device 230 such as shown in FIG. 5. In a second example, a bit set corresponding to the activation signal ACTV is stored in the computing device 100, for example, in a predetermined or preset state.

The second memory device 110-2 includes the third memory physical channel 111-3 and a fourth memory physical channel MPHY 111-4. Each of the third memory physical channel 111-3 and the fourth memory physical channel 111-4 includes a physical connection that transmits data utilized in an arithmetic operation to the computing device 100 and that receives data utilized in an arithmetic operation from the computing device 100. Each of the third memory physical channel 111-3 and the fourth memory physical channel 111-4 is configured to convert data into an electrical, optical, or electromagnetic signal and convert signals into data. Each of the third memory physical channel 111-3 and the fourth memory physical channel 111-4 is configured to synchronize the computing device 100 and the third memory device 110-3 and detect any errors in data transmitted between the computing device 100 and the second memory device 110-2. The activation of the third memory physical channel 111-3 and the fourth memory physical channel 111-4 is determined based on which of the third memory physical channel 111-3 and the fourth memory physical channel 111-4 is connected to the computing device 100. Because the third memory physical channel 111-3, and not the fourth memory physical channel 111-4, is connected to the second control physical channel 101-2 of the computing device 100, the third memory physical channel 111-3 is activated, and the fourth memory physical channel 111-4 is deactivated.

The third memory device 110-3 includes a fifth memory physical channel MPHY 111-5 and the sixth memory physical channel 111-6. Each of the fifth memory physical channel 111-5 and the sixth memory physical channel 111-6 includes a physical connection that transmits data utilized in an arithmetic operation to the computing device 100 and that receives data utilized in an arithmetic operation from the computing device 100. Each of the fifth memory physical channel 111-5 and the sixth memory physical channel 111-6 is configured to convert data into an electrical, optical, or electromagnetic signal and convert signals into data. Each of the fifth memory physical channel 111-5 and the sixth memory physical channel 111-6 is configured to synchronize the computing device 100 and the third memory device 110-3 and detect any errors in data transmitted between the computing device 100 and the third memory device 110-3. The activation of the fifth memory physical channel 111-5 and the sixth memory physical channel 111-6 is determined based on which of the fifth memory physical channel 111-5 and the sixth memory physical channel 111-6 is connected to the computing device 100. Because the sixth memory physical channel 111-6, and not the fifth memory physical channel 111-5, is connected to the third control physical channel 101-3 of the computing device 100, the fifth memory physical channel 111-5 is deactivated, and the sixth memory physical channel 111-6 is activated.

The fourth memory device 110-4 includes the seventh memory physical channel 111-7 and an eighth memory physical channel MPHY 111-8. Each of the seventh memory physical channel 111-7 and the eighth memory physical channel 111-8 includes a physical connection that transmits data utilized in an arithmetic operation to the computing device 100 and that receives data utilized in an arithmetic operation from the computing device 100. Each of the seventh memory physical channel 111-7 and the eighth memory physical channel 111-8 is configured to convert data into an electrical, optical, or electromagnetic signal and convert signals into data. Each of the seventh memory physical channel 111-7 and the eighth memory physical channel 111-8 is configured to synchronize the computing device 100 and the fourth memory device 110-4 and detect any errors in data transmitted between the computing device 100 and the fourth memory device 110-4. The activation of the seventh memory physical channel 111-7 and the eighth memory physical channel 111-8 is determined based on which of the seventh memory physical channel 111-7 and the eighth memory physical channel 111-8 is connected to the computing device 100. Because the seventh memory physical channel 111-7, and not the eighth memory physical channel 111-8, is connected to the fourth control physical channel 101-4 of the computing device 100, the seventh memory physical channel 111-7 is activated, and the eighth memory physical channel 111-8 is deactivated.

The fifth memory device 110-5 includes a ninth memory physical channel MPHY 111-9 and the tenth memory physical channel 111-10. Each of the ninth memory physical channel 111-9 and the tenth memory physical channel 111-10 r includes a physical connection that transmits data utilized in an arithmetic operation to the computing device 100 and that receives data utilized in an arithmetic operation from the computing device 100. Each of the ninth memory physical channel 111-9 and the tenth memory physical channel 111-10 is configured to convert data into an electrical, optical, or electromagnetic signal and convert signals into data. Each of the ninth memory physical channel 111-9 and the tenth memory physical channel 111-10 is configured to synchronize the computing device 100 and the fifth memory device 110-5 and detect any errors in data transmitted between the computing device 100 and the fifth memory device 110-5. The activation of each of the ninth memory physical channel 111-9 and the tenth memory physical channel 111-10 is determined based on which of the ninth memory physical channel 111-9 and the tenth memory physical channel 111-10 is connected to the computing device 100. Because the tenth memory physical channel 111-10, and not the ninth memory physical channel 111-9, is connected to the fifth control physical channel 101-5 of the computing device 100, the ninth memory physical channel 111-9 is deactivated, and the tenth memory physical channel 111-10 is activated.

The sixth memory device 110-6 includes the eleventh memory physical channel 111-11 and a twelfth memory physical channel MPHY 111-12. Each of the eleventh memory physical channel 111-11 and the twelfth memory physical channel 111-12 includes a physical connection that transmits data utilized in an arithmetic operation to the computing device 100 and that receives data utilized in an arithmetic operation from the computing device 100. Each of the eleventh memory physical channel 111-11 and the twelfth memory physical channel 111-12 is configured to convert data into an electrical, optical, or electromagnetic signal and convert signals into data. Each of the eleventh memory physical channel 111-11 and the twelfth memory physical channel 111-12 is configured to synchronize the computing device 100 and the sixth memory device 110-6 and detect any errors in data transmitted between the computing device 100 and the sixth memory device 110-6. The activation of the eleventh memory physical channel 111-11 and the twelfth memory physical channel 111-12 is determined based on which of the eleventh memory physical channel 111-11 and the twelfth memory physical channel 111-12 is connected to the computing device 100. Because the eleventh memory physical channel 111-11, and not the twelfth memory physical channel 111-12, is connected to the sixth control physical channel 101-6 of the computing device 100, the eleventh memory physical channel 111-11 is activated, and the twelfth memory physical channel 111-12 is deactivated.

The seventh memory device 110-7 includes a thirteenth memory physical channel MPHY 111-13 and the fourteenth memory physical channel 111-14. Each of the thirteenth memory physical channel 111-13 and the fourteenth memory physical channel 111-14 includes a physical connection that transmits data utilized in an arithmetic operation to the computing device 100 and that receives data utilized in an arithmetic operation from the computing device 100. Each of the thirteenth memory physical channel 111-13 and the fourteenth memory physical channel 111-14 is configured to convert data into an electrical, optical, or electromagnetic signal and convert signals into data. Each of the thirteenth memory physical channel 111-13 and the fourteenth memory physical channel 111-14 is configured to synchronize the computing device 100 and the seventh memory device 110-7 and detect any errors in data transmitted between the computing device 100 and the seventh memory device 110-7. The activation of the thirteenth memory physical channel 111-13 and the fourteenth memory physical channel 111-14 is determined based on which of the thirteenth memory physical channel 111-13 and the fourteenth memory physical channel 111-14 is connected to the computing device 100. Because the fourteenth memory physical channel 111-14, and not the thirteenth memory physical channel 111-13, is connected to the seventh control physical channel 101-7 of the computing device 100, the thirteenth memory physical channel 111-13 is deactivated, and the fourteenth memory physical channel 111-14 is activated.

The eighth memory device 110-8 includes the fifteenth memory physical channel 111-15 and a sixteenth memory physical channel MPHY 111-16. Each of the fifteenth memory physical channel 111-15 and the sixteenth memory physical channel 111-16 includes a physical connection that transmits data utilized in an arithmetic operation to the computing device 100 and that receives data utilized in an arithmetic operation from the computing device 100. Each of the fifteenth memory physical channel 111-15 and the sixteenth memory physical channel 111-16 is configured to convert data into an electrical, optical, or electromagnetic signal and convert signal into data. Each of the fifteenth memory physical channel 111-15 and the sixteenth memory physical channel 111-16 is configured to synchronize the computing device 100 and the eighth memory device 110-8 and detect any errors in data transmitted between the computing device 100 and the eighth memory device 110-8. The activation of the fifteenth memory physical channel 111-15 and the sixteenth memory physical channel 111-16 is determined based on which of the fifteenth memory physical channel 111-15 and the sixteenth memory physical channel 111-16 is connected to the computing device 100. Because the fifteenth memory physical channel 111-15, and not the sixteenth memory physical channel 111-16, is connected to the eighth control physical channel 101-8 of the computing device 100, the fifteenth memory physical channel 111-15 is activated, and the sixteenth memory physical channel 111-16 is deactivated.

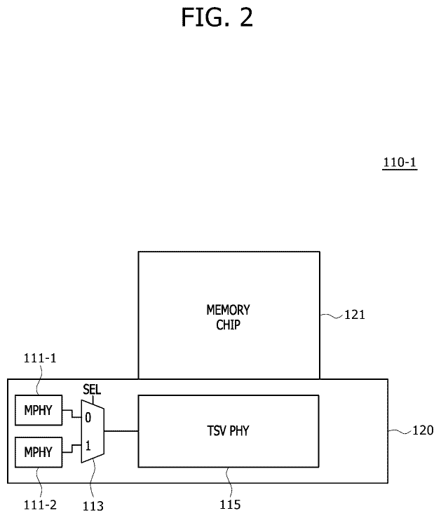

FIG. 2 illustrates a construction of the first memory device 110-1 according to an embodiment of the present disclosure.

As illustrated in FIG. 2, the first memory device 110-1 includes a base chip 120 and a memory chip 121.

The memory chip 121 is stacked on or over the base chip 120. The memory chip 121 includes a plurality of slice chips, for example, first slice chips 3120, 3130, 3140, and 3150 or second slice chips 3220, 3230, 3240, and 3250 as shown in FIG. 7. The quantity L of slice chips may be one of 4, 8, and 12. The present disclosure is not limited to these examples. A plurality of through silicon vias (TSV) is formed in each of the memory chip 121 and the base chip 120. The TSV structure facilitates electrical connection between the memory chip 121 and the base chip 120 and facilitates high-speed transfer of signals and data between the memory chip 121 and the base chip 120.

The base chip 120 includes the first memory physical channel 111-1, the second memory physical channel 111-2, a selector 113, and a TSV physical channel TSV PHY 115.

The first memory physical channel 111-1 and the second memory physical channel 111-2 includes a physical connection that transmits data utilized in an arithmetic operation to the computing device 100 and that receives data utilized in an arithmetic operation from the computing device 100.

The selector 113 connects one of the first memory physical channel 111-1 and the second memory physical channel 111-2 to the TSV physical channel 115 based on a selection signal SEL. The TSV physical channel 115 may be referred to as an output circuit. The logic level of the selection signal SEL is determined based on which of the first memory physical channel 111-1 and the second memory physical channel 111-2 is connected to the computing device 100. For example, when the first memory physical channel 111-1 and the computing device 100 are connected, the selection signal SEL is generated at a logic low level. When the second memory physical channel 111-2 and the computing device 100 are connected, the selection signal SEL is generated at a logic high level. The selector 113 is connected to the first memory physical channel 111-1 through a first terminal 0 and is connected to the second memory physical channel 111-2 through a second terminal 1. The selector 113 connects the first terminal 0 or the second terminal 1 to the TSV physical channel 115 based on the selection signal SEL. For example, when the first memory physical channel 111-1 and the computing device 100 are connected and the selection signal SEL is at a logic low level, the selector 113 connects the first memory physical channel 111-1 and the TSV physical channel 115 through the first terminal 0; and when the second memory physical channel 111-2 and the computing device 100 are connected and the selection signal SEL is at a logic high level, the selector 113 connects the second memory physical channel 111-2 and the TSV physical channel 115 through the second terminal 1.

The TSV physical channel 115 transmits and receives signals and data through the TSVs connected to the memory chip 121. The TSV physical channel 115 transmits data through the TSVs during a write operation on the memory chip 121 and receives data through the TSVs during a read operation on the memory chip 121.

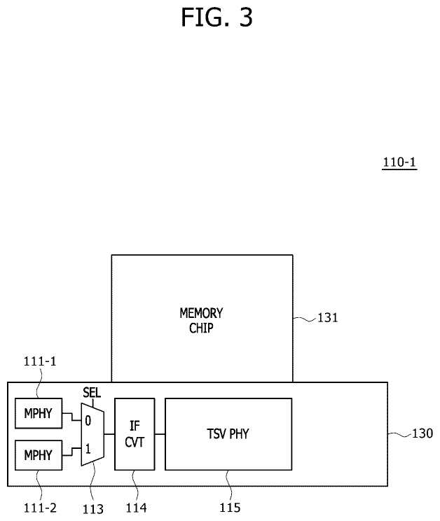

FIG. 3 illustrates a construction of the first memory device 110-1 according to an embodiment of the present disclosure.

As illustrated in FIG. 3, the first memory device 110-1 includes a base chip 130 and a memory chip 131.

The memory chip 131 is stacked on or over the base chip 130. The memory chip 131 includes a plurality of slice chips, for example, first slice chips 3120, 3130, 3140, and 3150 or second slice chips 3220, 3230, 3240, and 3250 as shown in FIG. 7. The quantity L of slice chips may be one of 4, 8, 12, and 16. The present disclosure is not limited to these examples. A plurality of TSVs is formed in each of the memory chip 131 and the base chip 130. The TSV structure facilitates electrical connection through the memory chip 131 and the base chip 130 and facilitates high-speed transfer of signals and data between the memory chip 131 and the base chip 130.

The base chip 130 includes the first memory physical channel 111-1, the second memory physical channel 111-2, the selector 113, an interface conversion circuit (IF CVT) 114, and the TSV physical channel TSV PHY 115.

The first memory physical channel 111-1 and the second memory physical channel 111-2 includes a physical connection that transmits data utilized in an arithmetic operation to the computing device 100 and that receives data utilized in an arithmetic operation from the computing device 100.

The selector 113 connects one of the first memory physical channel 111-1 and the second memory physical channel 111-2 to the interface conversion circuit 114 based on a selection signal SEL. The interface conversion circuit 114 may be referred to as an output circuit. The logic level of the selection signal SEL is determined based on which of the first memory physical channel 111-1 and the second memory physical channel 111-2 is connected to the computing device 100. The selector 113 is connected to the first memory physical channel 111-1 through a first terminal 0, and is connected to the second memory physical channel 111-2 through a second terminal 1. The selector 113 connects the first terminal 0 or the second terminal 1 to the interface conversion circuit 114 based on the selection signal SEL. For example, when the first memory physical channel 111-1 and the computing device 100 are connected and the selection signal SEL is at a logic low level, the selector 113 connects the first memory physical channel 111-1 and the interface conversion circuit 114 through the first terminal 0; and when the second memory physical channel 111-2 and the computing device 100 are connected and the selection signal SEL is at a logic high level, the selector 113 connects the second memory physical channel 111-2 and the interface conversion circuit 114 through the second terminal 1.

The interface conversion circuit 114 is connected between the TSV physical channel 115 and one of the first memory physical channel 111-1 and the second memory physical channel 111-2. The first memory physical channel 111-1 and the second memory physical channel 111-2 receive and transmit data using a first interface, and the TSV physical channel 115 receives and transmits data using a second interface. The interface conversion circuit 114 converts data between the first interface and the second interface. For example, the interface conversion circuit 114 receives data according to the first interface from the first memory physical channel 111-1 or the second memory physical channel 111-2, converts the data according to the first interface into data according to the second interface, and transmits the data according to the second interface to the TSV physical channel 115. For example, the interface conversion circuit 114 receives data according to the second interface from the TSV physical channel 115, converts the data according to the second interface into data according to the first interface, and transmits the data according to the first interface to the first memory physical channel 111-1 or the second memory physical channel 111-2. The first interface is different from the second interface.

The TSV physical channel 115 transmits and receives signals and data through the TSVs connected to the memory chip 131. The TSV physical channel 115 transmits data through the TSVs during a write operation on the memory chip 131 and receives data through the TSVs during a read operation on the memory chip 131.

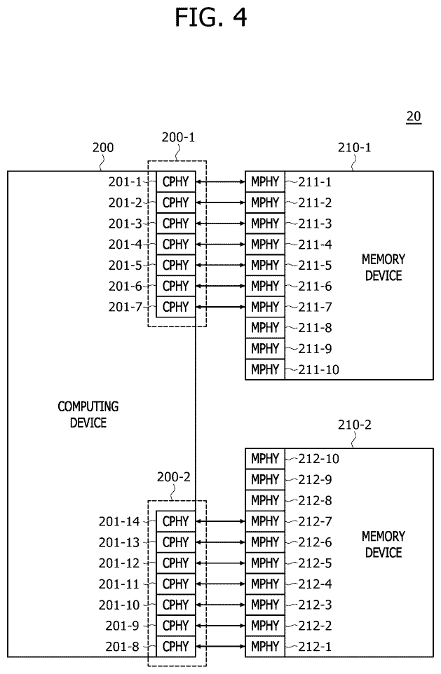

FIG. 4 illustrates a construction of a memory system 20 according to an embodiment of the present disclosure.

As illustrated in FIG. 4, the memory system 20 includes a computing device 200, a first memory device 210-1, and a second memory device 210-2.

The computing device 200 is implemented with a processor, for example, processor 3300 in FIG. 7, that performs operations to facilitate various tasks. The computing device 200 may include any of a CPU that controls the execution of an operating system and software, a GPU that controls graphic rendering and parallel processing tasks, and an NPU that controls artificial intelligence and machine learning tasks, such as neural network inference and training. The computing device 200 stores data utilized in an arithmetic operation in the first memory device 210-1 and the second memory device 210-2. The computing device 100 reads data utilized in an arithmetic operation from the first memory device 210-1 and the second memory device 210-2.

The computing device 200 includes control physical channels CPHY 201-1, 201-2, 201-3, 201-4, 201-5, 201-6, 201-7, 201-8, 201-9, 201-10, 201-11, 201-12, 201-13, and 201-14. The control physical channels 201-1, 201-2, 201-3, 201-4, 201-5, 201-6, and 201-7 may be disposed near or at a first edge 200-1 of the computing device 200. The control physical channels 201-8, 201-9, 201-10, 201-11, 201-12, 201-13, and 201-14 may be disposed near or at a second edge 200-2 of the computing device 200. The first edge 200-1 and the second edge 200-2 may be disposed in opposite ends the computing device 100 or along opposite ends of one edge of the computing device 100. The present disclosure is not limited to these examples.

The control physical channels 201-1, 201-2, 201-3, 201-4, 201-5, 201-6, and 201-7 are electrically connected to memory physical channels MPHY 211-1, 211-2, 211-3, 211-4, 211-5, 211-6, and 211-7 of the first memory device 210-1, respectively. Each of the control physical channels 201-1, 201-2, 201-3, 201-4, 201-5, 201-6, and 201-7 includes a physical connection that transmits data utilized in an arithmetic operation to the first memory device 210-1 and that receives data utilized in an arithmetic operation from the first memory device 210-1. Each of the control physical channels 201-1, 201-2, 201-3, 201-4, 201-5, 201-6, and 201-7 is configured to convert data into an electrical, optical, or electromagnetic signal and convert signals into data. Each of the control physical channels 201-1, 201-2, 201-3, 201-4, 201-5, 201-6, and 201-7 is configured to synchronize the computing device 200 and the first memory device 210-1 and detect any errors in data transmitted between the computing device 200 and the first memory device 210-1.

The control physical channels 201-8, 201-9, 201-10, 201-11, 201-12, 201-13, and 201-14 are electrically connected to memory physical channels MPHY 212-1, 212-2, 212-3, 212-4, 212-5, 212-6, and 212-7 of the second memory device 210-2, respectively. Each of the control physical channels 201-8, 201-9, 201-10, 201-11, 201-12, 201-13, and 201-14 includes a physical connection that transmits data utilized in an arithmetic operation to the second memory device 210-2 and that receives data utilized in an arithmetic operation from the second memory device 210-2. Each of the control physical channels 201-8, 201-9, 201-10, 201-11, 201-12, 201-13, and 201-14 is configured to convert data into an electrical, optical, or electromagnetic signal and convert signals into data. Each of the control physical channels 201-8, 201-9, 201-10, 201-11, 201-12, 201-13, and 201-14 is configured to synchronize the computing device 200 and the second memory device 210-2 and detect any errors in data transmitted between the computing device 200 and the second memory device 210-2.

The first memory device 210-1 includes the memory physical channels 211-1, 211-2, 211-3, 211-4, 211-5, 211-6, 211-7, 211-8, 211-9, and 211-10. Each of the memory physical channels 211-1, 211-2, 211-3, 211-4, 211-5, 211-6, 211-7, 211-8, 211-9, and 211-10 includes a physical connection that transmits data utilized in an arithmetic operation to the computing device 200 and that receives data utilized in an arithmetic operation from the computing device 200. Each of the memory physical channels 211-1, 211-2, 211-3, 211-4, 211-5, 211-6, 211-7, 211-8, 211-9, and 211-10 is configured to convert data into an electrical, optical, or electromagnetic signal and convert signals into data. Each of the memory physical channels 211-1, 211-2, 211-3, 211-4, 211-5, 211-6, 211-7, 211-8, 211-9, and 211-10 is configured to synchronize the computing device 200 and the first memory device 210-1 and detect any errors in data transmitted between the computing device 200 and the first memory device 210-1. The activation of each of the memory physical channels 211-1, 211-2, 211-3, 211-4, 211-5, 211-6, 211-7, 211-8, 211-9, and 211-10 is determined based on which of the memory physical channels 211-1, 211-2, 211-3, 211-4, 211-5, 211-6, 211-7, 211-8, 211-9, and 211-10 is connected to the computing device 200. Because the memory physical channels 211-1, 211-2, 211-3, 211-4, 211-5, 211-6, and 211-7, among the memory physical channels 211-1, 211-2, 211-3, 211-4, 211-5, 211-6, 211-7, 211-8, 211-9, and 211-10, are connected to the control physical channels 201-1, 201-2, 201-3, 201-4, 201-5, 201-6, and 201-7 of the computing device 200, respectively, each of the memory physical channels 211-1, 211-2, 211-3, 211-4, 211-5, 211-6, and 211-7 is activated, and each of the memory physical channels 211-8, 211-9, and 211-10 is deactivated. For example, which of the memory physical channels 211-1, 211-2, 211-3, 211-4, 211-5, 211-6, 211-7, 211-8, 211-9, and 211-10 to activate is determined by an activation signal transmitted by the computing device 200, for example, activation signal ACTV such as shown in FIG. 5 and FIG. 6. In a first example, the activation signal ACTV such as shown in FIG. 5 and FIG. 6) is generated by the computing device 200 that issues or transmits an acknowledgement request signal REQ to the memory device 210-1, such as shown in FIG. 5 and the computing device 200 receives an acknowledgement signal ACK such as shown in FIG. 5. In a second example, a bit set corresponding to the activation signal ACTV is stored in the computing device 100, for example, in a predetermined or preset state.

The second memory device 210-2 includes the memory physical channels 212-1, 212-2, 212-3, 212-4, 212-5, 212-6, 212-7, 212-8, 212-9, and 212-10. Each of the memory physical channels 212-1, 212-2, 212-3, 212-4, 212-5, 212-6, 212-7, 212-8, 212-9, and 212-10 includes a physical connection that transmits data utilized in an arithmetic operation to the computing device 200 and that receives data utilized in an arithmetic operation from the computing device 200. Each of the memory physical channels 212-1, 212-2, 212-3, 212-4, 212-5, 212-6, 212-7, 212-8, 212-9, and 212-10 is configured to convert data into an electrical, optical, or electromagnetic signal and convert signals into data. Each of the memory physical channels 212-1, 212-2, 212-3, 212-4, 212-5, 212-6, 212-7, 212-8, 212-9, and 212-10 is configured to synchronize the computing device 200 and the second memory device 210-2 and detect any errors in data transmitted between the computing device 200 and the second memory device 210-2. The activation of each of the memory physical channels 212-1, 212-2, 212-3, 212-4, 212-5, 212-6, 212-7, 212-8, 212-9, and 212-10 is determined based on which of the memory physical channels 212-1, 212-2, 212-3, 212-4, 212-5, 212-6, 212-7, 212-8, 212-9, and 212-10 is connected to the computing device 200. Because the memory physical channels 212-1, 212-2, 212-3, 212-4, 212-5, 212-6, and 212-7, among the memory physical channels 212-1, 212-2, 212-3, 212-4, 212-5, 212-6, 212-7, 212-8, 212-9, and 212-10, are connected to the control physical channels 201-8, 201-9, 201-10, 201-11, 201-12, 201-13, and 201-14 of the computing device 200, respectively, each of the memory physical channels 212-1, 212-2, 212-3, 212-4, 212-5, 212-6, and 212-7 is activated, and each of the memory physical channels 212-8, 212-9, and 212-10 is deactivated. For example, which of the memory physical channels 212-1, 212-2, 212-3, 212-4, 212-5, 212-6, 212-7, 212-8, 212-9, and 212-10 to activate is determined by an activation signal transmitted by the computing device 200, for example, activation signal ACTV such as shown in FIG. 5 and FIG. 6.

FIG. 5 and FIG. 6 illustrate a computing device and a memory device including signals utilized during a method of determining whether to activate memory physical channels in a memory system 22 according to an embodiment of the present disclosure.

As illustrated in FIG. 5 and FIG. 6, the memory system 22 includes a computing device 220 and a memory device 230.

The computing device 220 is implemented with a processor, for example, processor 3300 in FIG. 7, that performs operations to facilitate various tasks. The computing device 220 may include any of a CPU that controls the execution of an operating system and software, a GPU that controls graphic rendering and parallel processing tasks, and an NPU that controls artificial intelligence and machine learning tasks, such as neural network inference and training. The computing device 220 stores data utilized in an arithmetic operation in the memory device 230. The computing device 220 reads data utilized in an arithmetic operation from the memory device 230.

The computing device 220 includes control physical channels CPHY 221-1, 221-2, 221-3, 221-4, 221-5, and 221-6. The control physical channels 221-3, 221-4, 221-5, and 221-6 are electrically connected to memory physical channels MPHY 231-1, 231-2, 231-3, and 231-4 of the memory device 230, respectively. Each of the control physical channels 221-1, 221-2, 221-3, 221-4, 221-5, and 221-6 includes a physical connection that transmits data utilized in an arithmetic operation to the memory device 230 and that receives data utilized in an arithmetic operation from the memory device 230. Each of the control physical channels 221-1, 221-2, 221-3, 221-4, 221-5, and 221-6 is configured to convert data into an electrical, optical, or electromagnetic signal and convert signals into data. Each of the control physical channels 221-1, 221-2, 221-3, 221-4, 221-5, and 221-6 is configured to synchronize the computing device 220 and the memory device 230 and detect any errors in data transmitted between the computing device 220 and the memory device 230.

The memory device 230 includes the memory physical channels 231-1, 231-2, 231-3, 231-4, 231-5, and 231-6. Each of the memory physical channels 231-1, 231-2, 231-3, 231-4, 231-5, and 231-6 includes a physical connection that transmits data utilized in an arithmetic operation to the computing device 220 and that receives data utilized in an arithmetic operation from the computing device 220. Each of the memory physical channels 231-1, 231-2, 231-3, 231-4, 231-5, and 231-6 is configured to convert data into an electrical, optical, or electromagnetic signal and convert signal into data. Each of the memory physical channels 231-1, 231-2, 231-3, 231-4, 231-5, and 231-6 is configured to synchronize the computing device 220 and the memory device 230 and detect any errors in data transmitted between the computing device 220 and the memory device 230.

The activation of the memory physical channels 231-1, 231-2, 231-3, 231-4, 231-5, and 231-6 is determined based on which of the memory physical channels 231-1, 231-2, 231-3, 231-4, 231-5, and 231-6 is connected to the computing device 220.

An example of an operation including determining whether to activate the memory physical channels 231-1, 231-2, 231-3, 231-4, 231-5, and 231-6 is described with reference to FIG. 5.

An acknowledgement request signal REQ is issued or transmitted to the memory device 230 via each of the control physical channels 221-1, 221-2, 221-3, 221-4, 221-5, and 221-6 of the computing device 220. Each of the memory physical channels 231-1, 231-2, 231-3, and 231-4 connected to the control physical channels 221-3, 221-4, 221-5, and 221-6, respectively, among the control physical channels 221-1, 221-2, 221-3, 221-4, 221-5, and 221-6, receives the acknowledgement request signal REQ.

Each of the memory physical channels 231-1, 231-2, 231-3, and 231-4 is configured to issue or transmit an acknowledgement signal ACK to each of the control physical channels 221-3, 221-4, 221-5, and 221-6 of the computing device 220 in response to receiving the acknowledgement request signal REQ.

The computing device 220 generates the activation signal ACTV based on the acknowledgement signal ACK received through each of the control physical channels 221-3, 221-4, 221-5, and 221-6. The activation signal ACTV includes or indicates multiple bits that indicate a connection relation between the plurality of memory physical channels and the control physical channel. In this example, a bit set included in or corresponding to the activation signal ACTV indicates that the control physical channels 221-3, 221-4, 221-5, and 221-6 are connected to the memory physical channels 231-1, 231-2, 231-3, and 231-4, respectively.

The computing device 220 transmits the activation signal ACTV indicating that the control physical channels 221-3, 221-4, 221-5, and 221-6 are connected to the memory physical channels 231-1, 231-2, 231-3, and 231-4 from an activation transmission circuit TX-ACT 223.

The memory device 230 receives the activation signal ACTV through an activation reception circuit RX-ACT 232, and controls the activation of the memory physical channels 231-1, 231-2, 231-3, 231-4, 231-5, and 231-6 based on the activation signal ACTV. Thus, the memory device 230 activates the memory physical channels 231-1, 231-2, 231-3, and 231-4 connected to the control physical channels 221-3, 221-4, 221-5, and 221-6, respectively, based on the activation signal ACTV. The memory device 230 may deactivate each of the memory physical channels 231-5 and 231-6. The activated memory physical channels 211-1, 211-2, 211-3, and 211-4 may transmit or receive data utilized in an arithmetic operation.

Another example of an operation of determining which of the memory physical channels 231-1, 231-2, 231-3, 231-4, 231-5, and 231-6 to activate is described with reference to FIG. 6.

When the computing device 220 includes information indicating how the control physical channels 221-1, 221-2, 221-3, 221-4, 221-5, and 221-6 are connected to the memory physical channels 231-1, 231-2, 231-3, 231-4, 231-5, and 231-6, the computing device 220 generates the activation signal ACTV, in the example of FIG. 6, indicating that the control physical channels 221-3, 221-4, 221-5, and 221-6 are connected to the memory physical channels 231-1, 231-2, 231-3, and 231-4, respectively. The information indicating connections may be stored in the computing device 220.

The computing device 220 transmits, from the activation transmission circuit 223, the activation signal ACTV, indicating that the control physical channels 221-3, 221-4, 221-5, and 221-6 are connected to the memory physical channels 231-1, 231-2, 231-3, and 231-4, respectively.

The memory device 230 receives the activation signal ACTV through the activation reception circuit 232 and controls activation of the memory physical channels 231-1, 231-2, 231-3, 231-4, 231-5, and 231-6 based on the activation signal ACTV. In this example, the memory device 230 activates the memory physical channels 231-1, 231-2, 231-3, and 231-4 connected to the control physical channels 221-3, 221-4, 221-5, and 221-6, respectively based on the activation signal ACTV. The memory device 230 may deactivate each of the memory physical channels 231-5 and 231-6.

FIG. 7 is a block diagram illustrating a construction of a stack memory system 3 according to an embodiment of the present disclosure. As illustrated in FIG. 7, the stack memory system 3 includes a first stack memory device 3100, a second stack memory device 3200, a processor 3300, an interposer 3400, and a substrate 3500.

The interposer 3400 is formed on or over the substrate 3500. The first stack memory device 3100, the second stack memory device 3200, and the processor 3300 are formed on or over the interposer 3400. The processor 3300 may be formed between the first stack memory device 3100 and the second stack memory device 3200. The interposer 3400 electrically connects the substrate 3500, the first stack memory device 3100, the second stack memory device 3200, and the processor 3300. Because the pitch difference between the first stack memory device 3100, the second stack memory device 3200, and the processor 3300 may be large, the first stack memory device 3100, the second stack memory device 3200, and the processor 3300 are electrically connected, for example, utilizing conductive lines that are variously formed.

The processor 3300 includes a first controller 3310 that controls the first stack memory device 3100 and a first process interface circuit PHY 3320 that electrically connects the first stack memory device 3100 and the first controller 3310. The processor 3300 includes a second controller 3330 that controls the second stack memory device 3200 and a second process interface circuit 3340 that electrically connects the second stack memory device 3200 and the second controller 3330. The processor 3300 conveys signals, including a command and an address that control various internal operations of the first stack memory device 3100, to the first stack memory device 3100 through the first process interface circuit 3320 and receives signals from the first stack memory device 3100 through the first process interface circuit 3320. The processor 3300 conveys signals, including a command and an address that control various internal operations of the second stack memory device 3200, to the second stack memory device 3200 through the second process interface circuit 3340 and receives signals from the second stack memory device 3200 through the second process interface circuit 3340. The processor 3300 may be implemented with the computing device 100 illustrated in FIG. 1, the computing device 200 illustrated in FIG. 4, or the computing device 220 illustrated in FIG. 5 and FIG. 6.

The first stack memory device 3100 includes a first base chip 3110 and first slice chips 3120, 3130, 3140, and 3150. The first slice chips 3120, 3130, 3140, and 3150 are sequentially stacked on or over the first base chip 3110 and receive various signals from the first base chip 3110 through TSVs. The first stack memory device 3100 is formed including the four first slices 3120, 3130, 3140, and 3150, but may be formed by stacking various quantities of slice chips, such as 4, 8, 12, 16, or other quantities of slice chips. The first stack memory device 3100 may be implemented, for example, with any of the memory devices 110-1, 110-2, 110-3, 110-4, 110-5, 110-6, 110-7, and 110-8 illustrated in FIG. 1, the first memory device 110-1 illustrated in FIG. 2 and FIG. 3, the first memory device 210-1 and the second memory device 210-2 illustrated in FIG. 4, and the memory device 230 illustrated in FIG. 5 and FIG. 6.

The first base chip 3110 includes a first core interface circuit PHY 3111. The first core interface circuit 3111 enables communication with the first processor interface circuit 3320, receives signals transmitted by the processor 3300, and conveys, to the processor 3300, signals generated by the first slice chips 3120, 3130, 3140, and 3150.

The second stack memory device 3200 includes a second base chip 3210 and second slice chips 3220, 3230, 3240, and 3250. The second slice chips 3220, 3230, 3240, and 3250 are sequentially stacked on or over the second base chip 3210 and receive various signals from the second base chip 3210 through TSVs. The second stack memory device 3200 is formed including the four second slice chips 3220, 3230, 3240, and 3250, but may be formed by stacking various quantities of slice chips, such as 4, 6, 12, 16, or other quantities of slice chips. The second stack memory device 3200 may be implemented, for example, with any of the memory devices 110-1, 110-2, 110-3, 110-4, 110-5, 110-6, 110-7, and 110-8 illustrated in FIG. 1, the first memory device 110-1 illustrated in FIG. 2 and FIG. 3, the first memory device 210-1 and the second memory device 210-2 illustrated in FIG. 4, and the memory device 230 illustrated in FIG. 5 and FIG. 6.

The second base chip 3210 includes a second core interface circuit PHY 3211. The second core interface circuit 3211 enables communication with the second processor interface circuit 3330, receives signals transmitted by the processor 3300, and conveys, to the processor 3300, signals generated by the second slice chips 3220, 3230, 3240, and 3250.

The examples of various memory systems as described include adaptable physical connectivity that accommodates various different quantities of memory devices without limiting interconnections or bandwidth between computing devices and memory devices or forcing difficult physical connections that may compromise data transfer integrity. Adaptable physical connectivity facilitates improves interface between devices having different physical structures and layouts.

Concepts are disclosed in conjunction with examples and embodiments. Those skilled in the art will understand that various modifications, additions, and substitutions are possible without departing from the scope and technical concepts of the present disclosure. The embodiments disclosed in the present specification should be considered from an illustrative standpoint and not a restrictive standpoint. Therefore, the scope of the present disclosure is not limited to the above descriptions. All changes within the meaning and range of equivalency of the claims are included within their scope.

What is claimed is:

1. A memory system comprising:
a computing device comprising a control physical channel; and
a memory device comprising a plurality of memory physical channels;
wherein at least one memory physical channel, among the plurality of memory physical channels, is connected to the control physical channel and is activated.

2. The memory system of claim 1, wherein the computing device transmits and receives data utilized in an arithmetic operation through the control physical channel.

3. The memory system of claim 1, wherein the memory device receives and transmits data utilized in an arithmetic operation through the activated memory physical channel.

4. The memory system of claim 1, wherein the computing device transmits an acknowledgement request signal through the control physical channel.

5. The memory system of claim 4, wherein the memory device receives the acknowledgement request signal through the memory physical channel connected to the control physical channel and transmits an acknowledgement signal through the memory physical channel connected to the control physical channel.

6. The memory system of claim 5, wherein the computing device:
receives the acknowledgement signal through the control physical channel;
generates an activation signal that determines the activated memory physical channel; and
transmits the activation signal from an activation transmission circuit.

7. The memory system of claim 6, wherein the memory device:
receives the activation signal through an activation reception circuit; and
determines which of the plurality of memory physical channels to activate based on a bit set included in the activation signal.

8. The memory system of claim 1, wherein the computing device transmits, from an activation transmission circuit, an activation signal comprising a bit set based on a connection relation between the plurality of memory physical channels and the control physical channel.

9. The memory system of claim 8, wherein the memory device:
receives the activation signal through an activation reception circuit; and
determines which of the plurality of memory physical channels to activate based on the bit set included in the activation signal.

10. A memory system comprising:
a computing device comprising a first control physical channel and a second control physical channel; and
a first memory device comprising a first memory physical channel and a second memory physical channel,
wherein the first memory physical channel is activated when the first memory physical channel is connected to one of the first control physical channel and the second control physical channel, and the second memory physical channel is activated when the second memory physical channel is connected to one of the first control physical channel and the second control physical channel.

11. The memory system of claim 10, wherein, when the first memory physical channel is connected to the first control physical channel, the first memory physical channel is activated, and the second memory physical channel is deactivated.

12. The memory system of claim 11, wherein the first memory device receives and transmits data utilized in an arithmetic operation through the first memory physical channel.

13. The memory system of claim 10, wherein when the second memory physical channel is connected to the first control physical channel, the first memory physical channel is deactivated, and the second memory physical channel is activated.

14. The memory system of claim 13, wherein the first memory device receives and transmits data utilized in an arithmetic operation through the second memory physical channel.

15. The memory system of claim 10, further comprising a second memory device comprising a third memory physical channel and a fourth memory physical channel,
wherein the third memory physical channel is activated when the third memory physical channel is connected to one of the first control physical channel and the second control physical channel, and the fourth memory physical channel is activated when the fourth memory physical channel are connected to one of the first control physical channel and the second control physical channel.

16. The memory system of claim 15, wherein, when the third memory physical channel is connected to the second control physical channel, the third memory physical channel is activated, and the fourth memory physical channel is deactivated.

17. The memory system of claim 16, wherein the second memory device receives and transmits data utilized in an arithmetic operation through the third memory physical channel.

18. A memory system comprising:
a base chip; and
a memory chip stacked on or over the base chip and connected to the base chip using a through silicon via (TSV),
wherein the base chip comprises a selector configured to connect, based on a selection signal, an output circuit to one of a first memory physical channel and a second memory physical channel.

19. The memory system of claim 18, wherein each of the first memory physical channel and the second memory physical channel includes a physical connection that transmits data utilized in an arithmetic operation to a computing device and that receives the data utilized in the arithmetic operation from the computing device.

20. The memory system of claim 18, wherein the selector connects the first memory physical channel to the output circuit based on the selection signal when the first memory physical channel is connected to the computing device.

21. The memory system of claim 18, wherein the selector:
receives the selection signal is at a logic level determined based on a connection relation between the second memory physical channel and the computing device; and
connects the second memory physical channel to the output circuit based on the logic level of the selection signal.

22. The memory system of claim 18, wherein the output circuit is a TSV physical channel that transmits data through the TSV for a write operation on the memory chip and receives data through the TSV for a read operation on the memory chip.

23. The memory system of claim 18, wherein the output circuit is an interface conversion circuit that converts data between a first interface and a second interface.

24. A method comprising:
transmitting an acknowledgement request signal from a plurality of control physical channels included in a computing device to a plurality of memory physical channels included in a memory device;
in response to receiving the acknowledgement request signal, transmitting an acknowledgement signal from a subset of the plurality of memory physical channels included in the memory device to a subset of the plurality of control physical channels included in the computing device;
in response to receiving the acknowledgement signal, generating an activation signal indicating which of the subset of the plurality of memory physical channels is connected to which of the subset of the plurality of control physical channels;
transmitting the activation signal to the memory device; and
in response to receiving the activation signal, activating, by the memory device, the subset of the plurality of memory physical channels.
